(19) United States
(12) Patent Application Publication
(10) Pub. No.: US 2012/0022697 A1
(43) Pub. Date: Jan. 26, 2012

(54) SYSTEM, METHOD, AND COMPUTER PROGRAM PRODUCT FOR SIMULATED INSTABILITY IN EXERCISE EQUIPMENT

(76) Inventor: Joseph A. Cerrato, Longview, TX (US)

(21) Appl. No.: 13/190,467

(22) Filed: Jul. 25, 2011

Related U.S. Application Data
(60) Provisional application No. 61/367,065, filed on Jul. 23, 2010.

(51) Int. Cl. G05B 13/02

(52) U.S. Cl. 700/275

(57) ABSTRACT

A system, method, and, as an option, computer program product are provided for simulating spontaneous movement on a stability ball, half-stability ball, other exercise device, or with no accompanying exercise device. In operation, the user has the option of entering information into the device. Additionally, the device may adjust to a setting based upon the information entered, when available; otherwise, a default setting may be selected. Furthermore, the device may randomize direction of spinning motion and force of spinning motion applied to an exercise ball by translatory motion by the mobile apparatus of the invention. The purpose of this device is to allow a single individual to achieve and surpass the effectiveness of various exercises which would otherwise require two individuals in traditional fitness training; however, the device may also be applicable to non-fitness-related fields of study and practice.

### BACKGROUND AND FIELD OF THE INVENTION

The present invention relates to instability in exercise equipment, and more particularly to spontaneous motion in stability balls and half-stability balls for muscular and balance training.

### SUMMARY

A system, method, and, as an option, computer program product are provided for simulating spontaneous movement on a stability ball, half-stability ball, other exercise device, or with no accompanying exercise device. In operation, the user has the option of entering information into the device. Additionally, the device may adjust to a setting based upon the information entered, when available; otherwise, a default setting may be selected. Furthermore, the device may randomize direction of spinning motion and force of spinning motion applied to an exercise ball by translatory motion by the mobile apparatus of the invention. The purpose of this device is to allow a single individual to achieve and surpass the effectiveness of various exercises which would otherwise require two individuals in traditional fitness training; however, the device may also be applicable to non-fitness-related fields of study and practice.

### BRIEF DESCRIPTION OF THE DRAWINGS

FIG. 1 illustrates a system for executing semi-spontaneous movements in an embodiment with the absence of a computer program.

FIG. 2 shows an exemplary system in which the architecture of the various embodiments may be implemented to allow for the action and storage of exercise data, personal data, etc.

FIG. 3 illustrates an exemplary device architecture in which the non-stationary apparatus is detached from the casing, in accordance with one embodiment and with the optional accompaniment of a computer program.

FIG. 4 illustrates an exemplary device architecture in which the non-stationary apparatus is attached to the casing, in accordance with one embodiment and with the optional accompaniment of a computer program.

FIG. 5 illustrates an exemplary method for a computer program to simulate spontaneous movements by the apparatus.

### DETAILED DESCRIPTION

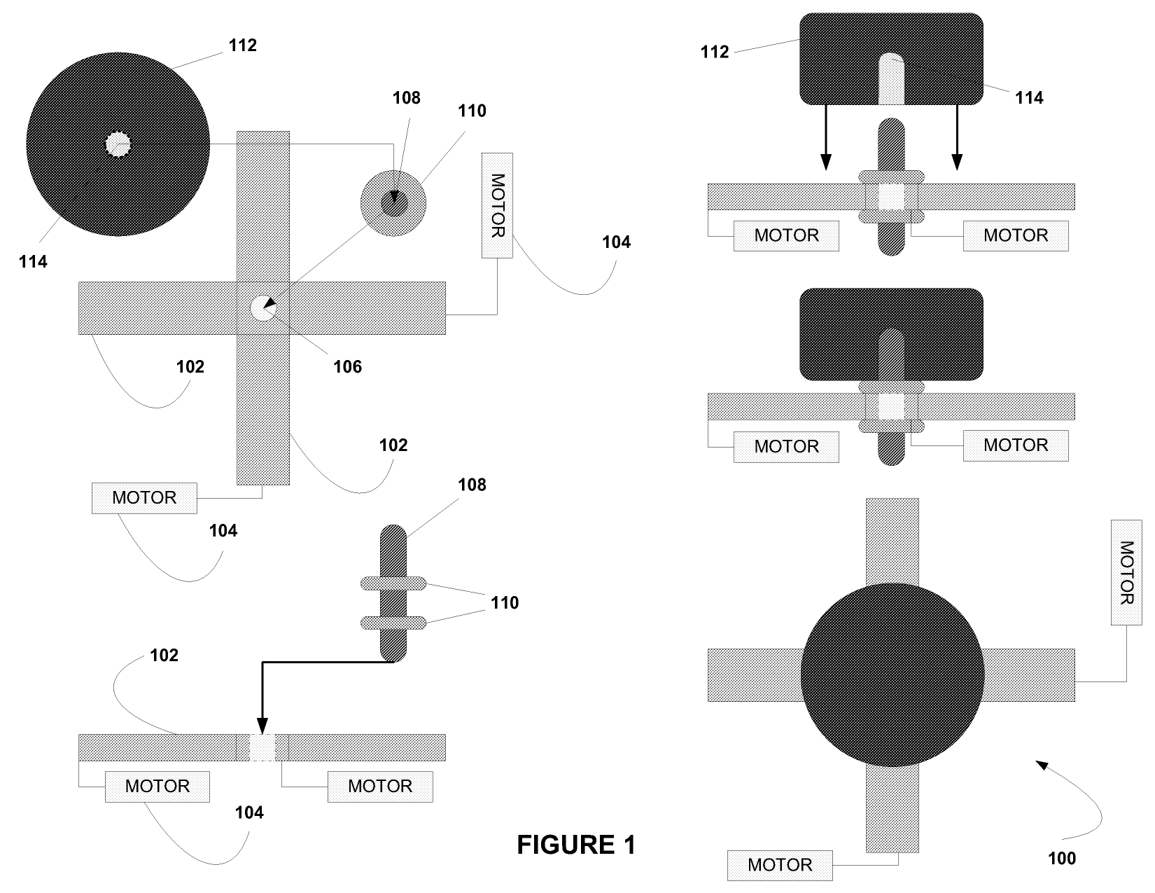

FIG. 1 illustrates a system 100 for executing semi-spontaneous movements in an embodiment with the absence of a computer program. The primary method of this system is that of a plotter function design. While this method is presented, it should be noted that various methods to achieve this semi-spontaneous and computer-free design are, of course, acceptable alternatives.

As previously mentioned, the system 100 acts as a plotter function in which two free-moving straight bands 102 are controlled by motors 104 and each band 102 has a hole 106 directly in the lengthwise middle of it. The hole of one band is equal to that of the other.

The two holes 106 are aligned on top of each other such that a rod 108 may be inserted through the overlapping holes and secured in place. As an example, FIG. 1 shows simple physical barriers 110 on each side of the bands in order to secure the rod 108. These barriers may be constructed from any appropriate material (metal alloy, a fluorocarbon or thermoplastic polymer, etc.); the substance should be able to withstand the compression force of a person's weight.

The overall system must be secured in such a way that the barriers 110 do not distort the structure of the bands 102, lest increased resistance be applied to the system which would stress the motors and/or inhibit free-motion operation of the apparatus. The system may or may not be housed inside the base to achieve this aim.

The rod's position will be indirectly controlled by the motors. Once activated, the motors 104 will move the bands 102 back and forth at any prescribed velocity—same or distinct from each other—in order to move the rod 108 in a semi-spontaneous pattern. As an option, the motors may have a controller system (not shown) in order to allow for deactivation of the motors separate from one another, which would further the spontaneity of the positions achieved by the system.

While the rod 108 is the centerpiece of the apparatus, its surface area is not large enough to offer support for the many target exercises of which is this system strives to accomplish. To resolve this issue, a platform 112 may be affixed over the rod 108.

The platform 112 may have a quasi-cylindrical hole 114 drilled into it in order to firmly secure the rod 108 in place. The platform 112 may be of various heights, though not necessarily varying.

The belts 102 may meet at any point on the Z-axis. It may be desirable to affix the platform 112 as near to the intersection as possible so as to limit the lever arm force that will be applied to the rod upon translatory motion.

As shown and previously mentioned, the rod may be secured below (Z-axis) the intersection by a physical barrier 110 (or other form of fastening) in order to alleviate forces applied on the lever arm of the rod 108. A tight fit between the rod 108 and the hole in the belts 106 may also ameliorate forces applied during motion.

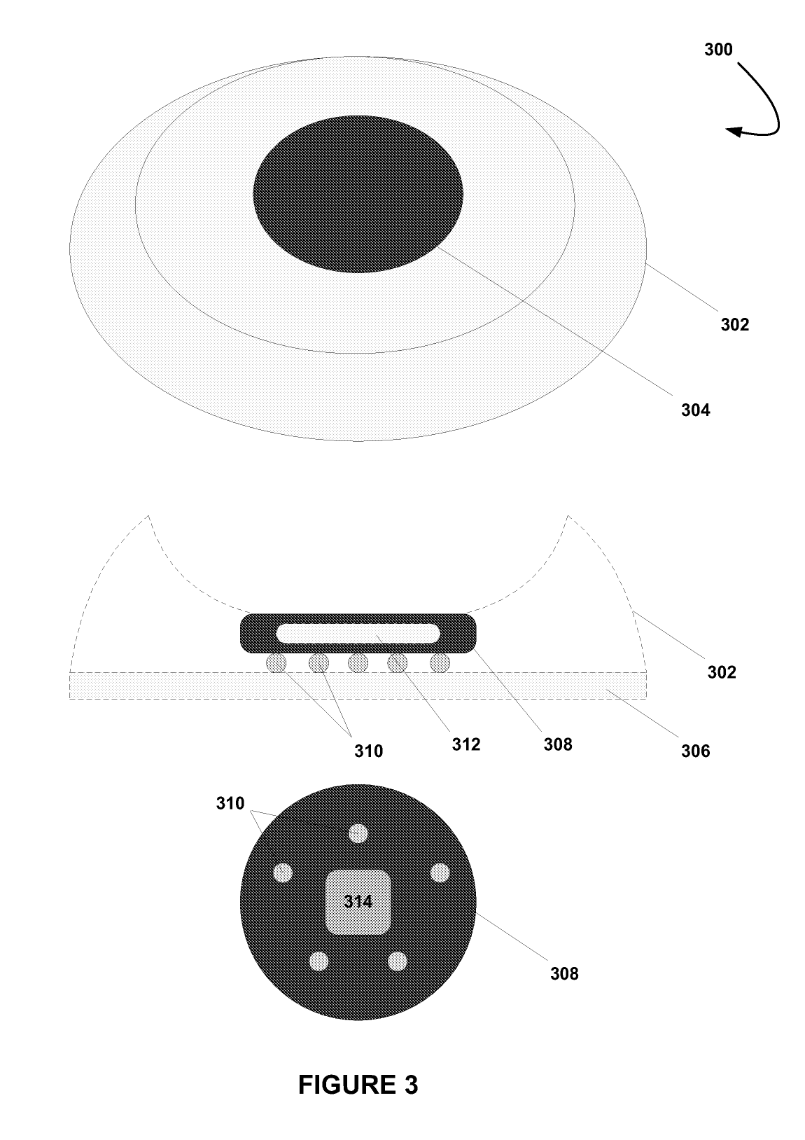

The platform 112 may be of any desired surface area. It may be desirable to fully cover the opening in the casing of the apparatus. FIG. 3 contains an illustration showing the outer casing of the design.

A great variety of exercises may be accomplished by this design, including many that have not been possible with just one individual. While the design's primary aim is that of allowing for a stability ball to be placed upon the platform and then exercises be performed by the user while on the stability ball to allow for advanced balance feats and more refined muscle engagement, a user may also utilize a variety of other existing fitness equipment in conjunction with this apparatus, such as an inverted half-stability ball, modified shoe-like devices, resistance bands, etc. Additionally, a user may use this design as a stand-alone device, performing normal balance and resistance exercises while on top of the platform with the system activated.

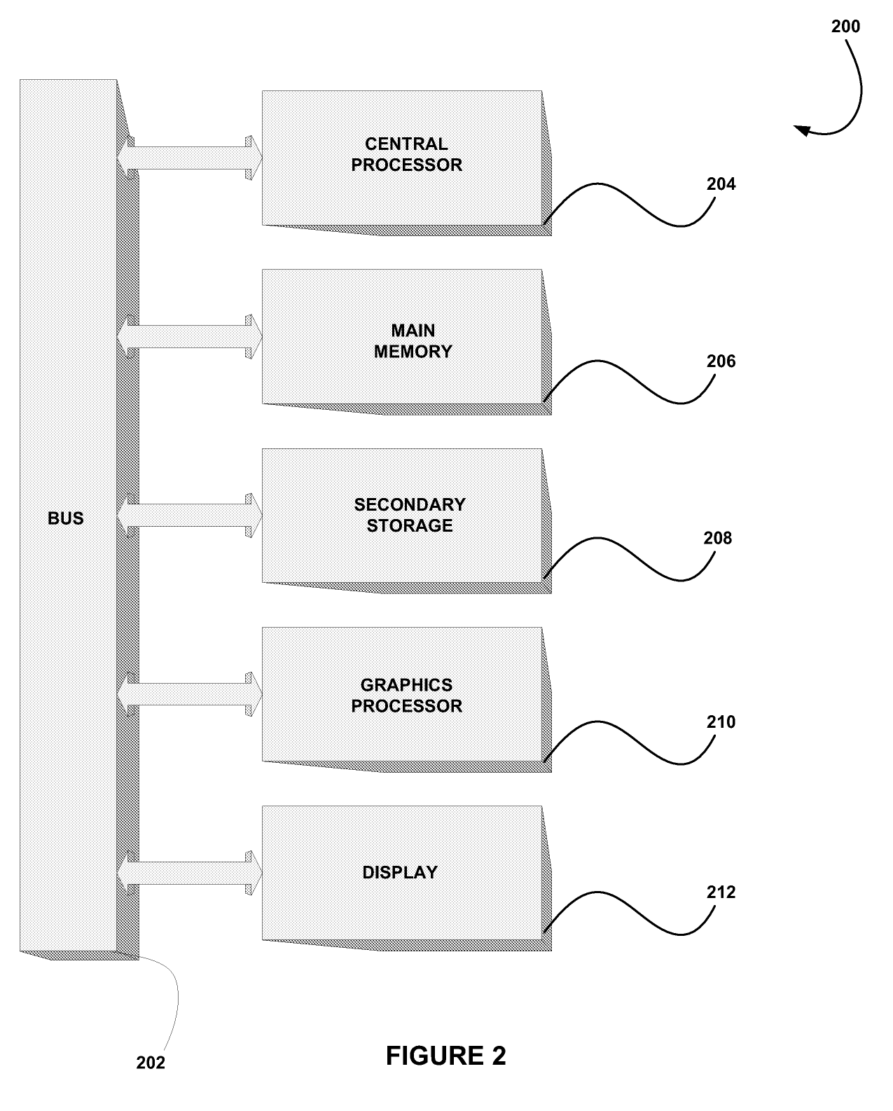

FIG. 2 illustrates an exemplary computer system 200, in which the embodiments and/or functionality of the various systems and architectures may be implemented. As an option, the computer system 200 may be implemented in the context of any of the device architectures that may optionally include a computer system. Of course, the computer system 200 may be implemented in any desired environment.

As shown, a computer system 200 is provided including at least one central processor 204 which is connected to a communication bus 202. The computer system 200 also includes main memory 206 [e.g. random access memory (RAM), etc.]. The computer system 200 also includes a graphics processor 210 and a display 212.

The computer system 200 may also include a secondary storage 208, though space is a consideration for the given device architecture(s). The secondary storage 212 includes, for example, a hard disk drive and/or a removable storage drive, representing a floppy disk drive, a magnetic tape drive, a compact disk drive, etc. The removable storage drive reads from and/or writes to a removable storage unit in a well-known manner. As an option, a USB drive may allow for a space-efficient method in which to permit exercise data storage and/or exercise program implementation.

Computer programs, or computer control logic algorithms, may be stored in the main memory 206 and/or the secondary storage 208. Such computer programs, when executed, enable the computer system 200 to perform various functions. Memory 206, storage 208, and/or any other storage are possible examples of computer-readable media.

The architecture and/or functionality of the previous figures may be implemented in the context of a general computer system, a circuit board system, an application-specific system, and/or any other desired system.

Furthermore, while not shown, the system 200 may be coupled to a network [e.g. a telecommunications network, local area network (LAN), wireless network, wide area network (WAN) such as the Internet, peer-to-peer network, cable network, etc.] for communication purposes.

Additionally, while the system 200 may be present in any combination of the equipment brought forth in the various architectures, it should also be understood that given the variance of the tasks required of each embodiment, the hardware may be significantly altered to most efficiently achieve the aforementioned tasks.

FIG. 3 illustrates an exemplary device architecture 300 in which the non-stationary apparatus is detached from the casing, in accordance with one embodiment and with the optional accompaniment of a computer program.

This illustration portrays a 3D angular projection view of the equipment in its entirety, followed by a 2D cross-sectional side view further detailing the mobile apparatus included as part of the equipment. Also shown is a representation of the mobile apparatus separated from the equipment as viewed from underneath the mobile apparatus.

The mobile apparatus consists of a platform 308, which may have a marginal space hollowed out of it 312, in order to allow for placement of a computer device and motor device (not shown) to allow for the integration and execution of a computerized randomization program that will simulate spontaneous motion in the mobile apparatus to achieve the desired fitness and exercise goals. Furthermore, the mobile apparatus may have any number of wheels 310 of any shape, or any other method of achieving translatory motion by the platform 308, attached to the platform.

The mobile apparatus may be housed in a case 302 with an opening 304 in the middle of the case allowing for the platform 308 to be exposed such as to permit for user interaction with the mobile apparatus. Optionally, the platform may be designed larger than the opening and may be aligned flush with the edges of the inner portion of the casing to facilitate necessary safety precautions.

The base 306 will support the concentrated weight of the user and/or equipment placed upon the platform 308 of which the force would then be distributed through the wheels 310 or other mobility-permitting device onto the base. As such, the base may be built accordingly with consideration to the pounds per square inch that will be applied to the structure of the invention with regards to the methods used by the device.

As shown, a battery compartment 314 may be housed in the underside of the platform 308. A method of accessing the battery compartment may be implemented into the design in various ways. As an option, the casing 302 may be detachable from the base 306. Alternatively, the battery compartment may be housed in the side of the platform 308 such that the user would simply be required to manually reposition the platform to allow for the hole 304 to gain separation from the platform and allow access to the side of the platform.

With regards to the implementation of a computer device into this method, a way of synchronizing the mobile apparatus precisely may be desired as an option as opposed to manually positioning the platform 308 in the assumed region. Since the mobile apparatus is separate from the rest of the structure, the task may require additional considerations in order to accomplish such synchronization. This operation is not shown in FIG. 3 but may be accomplished through use of—but not limited to—magnets, lasers, optical devices, mechanical realigning features, etc.

The surface area of the exposed portion of the platform 308 through the hole 304 may be designed in such a way to accommodate normal-sized stability balls. The surface area of a stability ball that would be in contact with the platform 308 would be dependent on the mass and gravity placed upon the ball, so this consideration may be slightly variable; however, overestimating the weight upon the ball would not lead to any major structural or operational hindrance, whereas underestimating the weight upon the ball may lead to greatly increased friction between the ball and the casing 302 and thus, limiting motion and applying further stress on the motor.

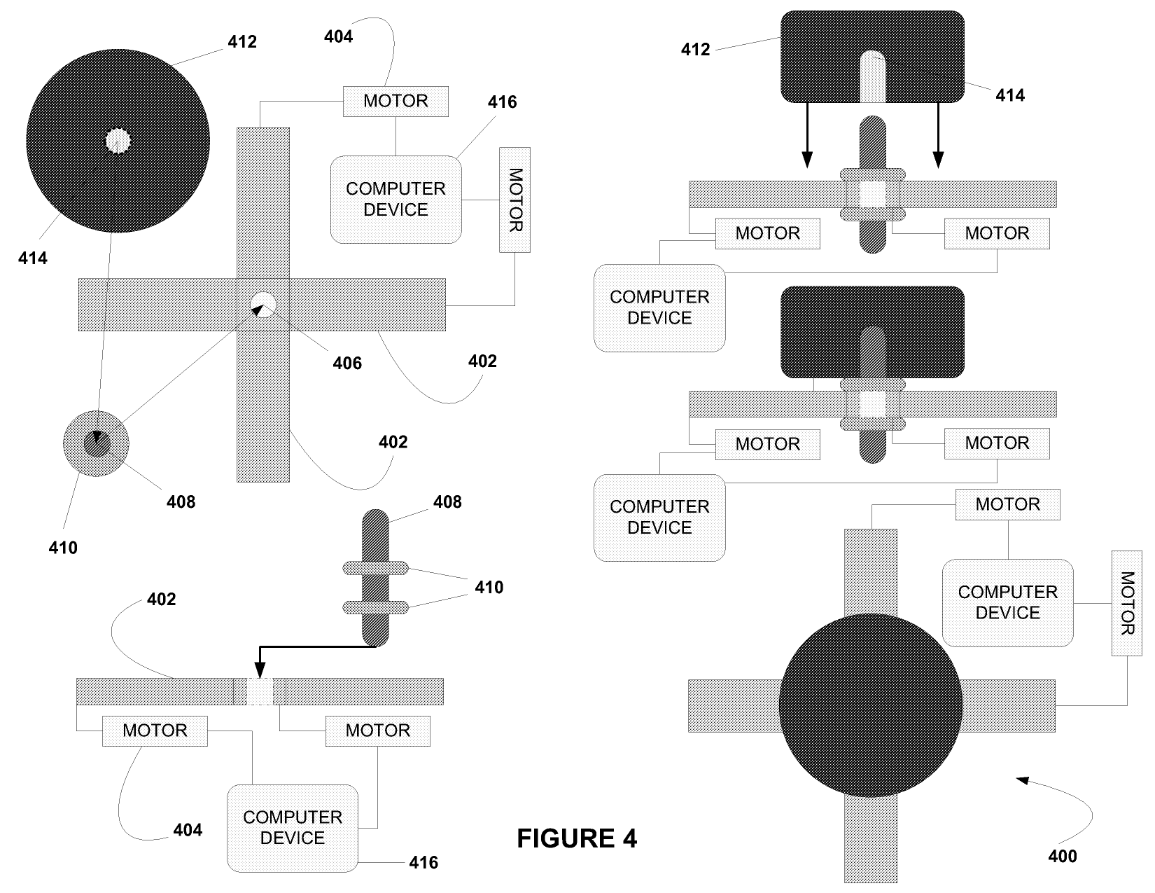

FIG. 4 illustrates an exemplary device architecture in which the non-stationary apparatus is attached to the casing, in accordance with one embodiment and with the optional accompaniment of a computer program.

This illustration and method is very similar to that which was presented in FIG. 1 with the exception of the addition of a computer device 416 to the architecture and a functional computer program to the method.

The identical structural designs presented in FIG. 4 are referenced in the detailed description of FIG. 1. The altered structure and method accompanying the addition of a computer device will be further elaborated upon as follows, but structural reiterations may be found and referred to via earlier documentation.

A computer device 416 may be implemented into the design to allow for a similar structural design as that of the plotter function method of operation; however, the computer program would allow for a more refined and spontaneous method to be incorporated into the invention.

Like with FIG. 3, a method of automated synchronization may be desirable in the presented method of FIG. 4. Since the mobile apparatus is attached to the stationary apparatus, this may be achieved more simply; however, any of a great variety of methods may still be incorporated into the design to accomplish this feat.

Unlike with FIG. 1, due to the implementation of a computer program into the design presented by FIG. 4, the motors 404—and consequently, the bands 402, rod 408, and platform 412—may be controlled by the computer device 416 to allow more spontaneous movements to be executed.

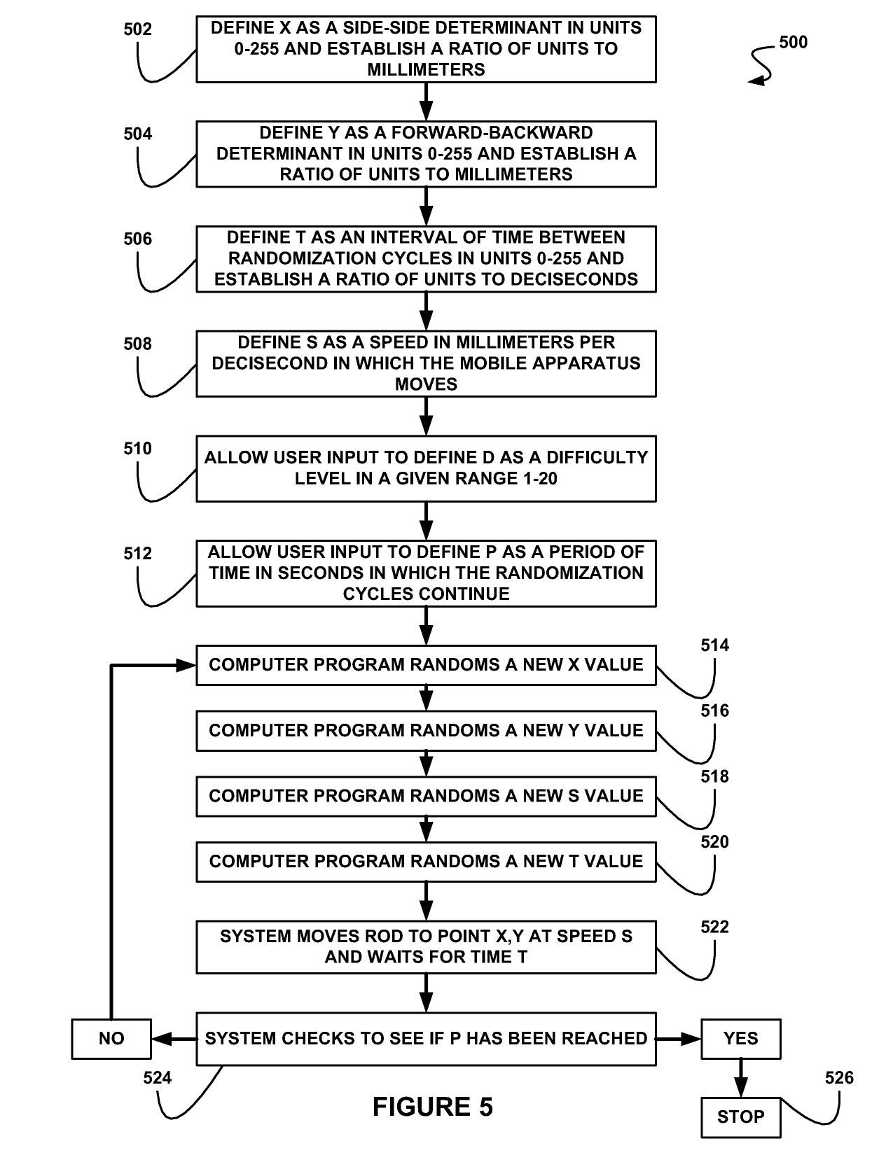

FIG. 5 illustrates an exemplary method 500 for a computer program to simulate spontaneous movements by the apparatus. It should be noted that all values and units shown are for demonstrative purposes only and should not be construed as specific or limiting aspects of the method presented or of the overall design or concept. This or any other computer program may be implemented in any of the previously presented embodiments which allow for computer integration.

In the context of the proposed exemplary method, a series of steps are presented that may allow an embodiment to implement a process in which variables may be assigned random values over an existing X-Y coordinate plane.

Additionally, the presented program may utilize durations of time in values that have been either specified or generated at random as a reference in order to determine various periods of activity and/or inactivity in the mobility of the apparatus.

Furthermore, the presented program may utilize varying degrees of velocity in regard to the mobile apparatus. In this way, another element may be added in which a difficulty level may be attained.

As shown by operation 502 in FIG. 5, a side-to-side determinant may be defined as a variable X and measured in any given range of units that may then have a correlating proportion of measurement. As an example, the program may define one unit to be equal to one millimeter. The program may then randomly assign X a numeric value between 0 and 255. The program would then store that number and proceed to the next operation. To reiterate, all values and ratios are provided for exemplary purposes only and may be reassigned as any fraction of any unit of measurement; a wholly different means of defining the variables is also a viable method.

As shown by operation 504 in FIG. 5, a forward-backward determinant may be defined as a variable Y and measured in any given range of units that may then have a correlating proportion of measurement. As an example, the program may define one unit to be equal to one millimeter. The program may then randomly assign Y a numeric value between 0 and 255. The program would then store that number and proceed to the next operation. To reiterate, all values and ratios are provided for exemplary purposes only and may be reassigned as any fraction of any unit of measurement; a wholly different means of defining the variables is also a viable method.

For simplicity, the proposed method assigns only positive values for X and Y, meaning that the values on the X-Y plane are only presented in the first quadrant of the plane. Using both positive and negative values to implement the standard four quadrants of the X-Y plane is one of several options to modifying the design, though ultimately, the functionality of the device would remain relatively unchanged. Additionally, the ratios of X and Y are presented as equal with respect to each other. Furthermore, one aspect that should be considered in the design when assigning metric ratios may be that an excessively large, or conversely, a very small range of movement of the mobile apparatus may detract from the efficacy of the device in achieving the purpose(s) of an exercise or training method.

In operation 506, the proposed method defines T as an interval of time between randomization cycles. This is the latent period of the mobile apparatus after it has moved to a new point. Just as the X and Y values are redefined after each movement, so may the T value be redefined to allow for increased spontaneity. The latent period timer may begin as the apparatus sets in motion to its destination point, or it may begin as the apparatus comes to a stop on its destination point. In the example set by FIG. 5, one unit may correlate to one decisecond. The program would store the value of T and proceed to the next operation. To reiterate, all values and ratios are provided for exemplary purposes only and may be reassigned as any fraction of any unit of measurement; a wholly different means of defining the variables is also a viable method.

In operation 508, the proposed method defines S as a rate of speed in which the mobile portion of the apparatus transitions from the initial point to the destination point. As before with the other variables, an option may be to allow the value of S to be redefined after each movement for further spontaneity. Additionally, as with the previous variables, a minimum and maximum velocity may be desirable as part of the structure of the program and/or in accordance with the capabilities or functionality of the machinery which drives the mobile apparatus. In the proposed exemplary method, S is defined in terms of millimeters per decisecond. The program would store the value of S and proceed to the next operation. To reiterate, all values and ratios are provided for exemplary purposes only and may be reassigned as any fraction of any unit of measurement; a wholly different means of defining the variables is also a viable method.

Because S may be long or short, and given its potential interaction with T, it may be desirable to add certain limiting ranges on one or both variables. As aforementioned, the latent period timer—defined by T—may begin as the apparatus sets in motion to its destination point, or it may begin as the apparatus comes to a stop on its destination point. Potential complications may arise with the combination of these proposed operations. For example, if the distance between the initial point (X₀,Y₀) and the destination point (X_{F},Y_{F}) is 40 millimeters, the latent period 10 deciseconds, and the speed is 3 millimeters per decisecond, then the latent period will expire before the destination point has been reached. This complication is true for any set of values in which S<(distance/T); for clarity, distance²=D²=[(X_{F}−X₀)²+(Y_{F}−Y₀)²], therefore distance=√D². The problem that may arise is such that the program will call for a new transition before the current transition is completed. Many options are available as potential solutions to this complication if a solution is desired. One solution allows for the reassignment of points mid-transition. Alternatively, the program could have limiting ranges providing a minimum T value such that given a maximum distance over a minimum speed, the smallest T value until the next transition cycle is still greater than the time it would take for the previous cycle to be completed. The area of the coordinate plane or the ranges of speed may likewise or alternatively be adjusted. Another option may be to set checks within the program such that an operation may not follow through if S<(D/T). For simplicity, it may be vastly more convenient for the period to simply begin after the mobile apparatus has stopped on its destination rather than immediately when the transition begins. This alternative may consist of higher duration latent periods, which may be desirable or undesirable depending on the individual, the current exercise, etc. In any case, the difference should be relatively minor, so whichever preferred method may be pursued without any notable detriment to the design.

Operation 510 illustrates the virtual “starting point” of the user interaction with the program as the prior steps are simply defining variables that will be used by the program to determine actions. Here the program allows the user to input a difficulty level, which the program will then use to define a value for a variable D. As an option, the user may alternatively be able to command the program to randomly determine a difficulty level.

The difficulty level, D, may be used to vary any number of existing defined variables. For example, the difficulty level may control the range of movement by placing or removing constrictions on the area in which the X-Y plane covers. It may also alter the latent time between randomization cycles. Furthermore, it may alter the speed at which the mobile apparatus may move. The extent of what may or may not be modified by any given difficulty level may be expanded to include other variables. The examples listed here are purely for elaboration and should not to be perceived as limiting to the overall design.

As an option, weight, fitness level, and other factors may be used by the program to auto-assign an estimated appropriate difficulty level.

The user may then be permitted to input a period of time for which they desire the exercise set to continue, as shown by operation 512. This will be defined as a variable P and may or may not be given a specific range of acceptable values. As an option, the difficulty setting may be permitted to alter the value of the variable P; however, this option is not specifically presented in FIG. 5.

As the period in which randomization cycles continue and the difficulty level (variables P and D, respectively) act independently from one another, they may, as an option, be interchanged in regards to the order in which they are presented to the user. The given exemplary method 500 illustrates the difficulty level input as being presented before the input regarding the period in which the randomization cycles continue.

At this point, all variables are defined in the system—some with values. The program will then initiate a loop that will continue until terminated by the instance in which the value of the variable P has been reached.

The following steps 514, 516, 518, and 520 in the program loop are interchangeable; that is, they may be implemented in any order, but they must all be implemented.

The first operation 514 in the program loop is such that the computer program randomly generates a new value for the variable X.

The second operation 516 in the program loop is such that the computer program randomly generates a new value for the variable Y.

The third operation 518 in the program loop is such that the computer program randomly generates a new value for the variable S.

The fourth operation 520 in the program loop is such that the computer program randomly generates a new value for the variable T.

At this point, the program has enough new information to initiate or continue movement of the apparatus. The system will now move the rod to point X,Y at a speed of S and wait for a time of T, as dictated by the program's sequence 522.

The last step 524 in the program loop according to the presented exemplary method 500 is for the program to check if the value of variable P has been reached—that is, has the system been active for P amount of time. If the check comes back negative, the program will continue to loop continuously until the defined period of time has been achieved by the system. Once a positive check returns, the system will issue a stop command 526 and reset the program. As an option, the apparatus may also reset the position of the rod. Alternatively, the system may simply “remember” what X and Y values (coordinates) it currently holds and leave the rod at its present location whenever the program itself resets.

All variables and units of measurement that have been presented are for demonstrative purposes only and should not be construed as specific or limiting aspects of the presented exemplary method.

What is claimed is:

1. A method, comprising:
utilizing computer randomization and/or using the facilitation of simple motors to generate random or semi-spontaneous motion in a device primarily but not exclusively for application to the fitness industry;
a device architecture rendering the equipment capable of supporting a wide range of users with consideration given to the hardware incorporated into the design;
a device architecture rendering the equipment ample compatibility with a wide range of existing exercise devices that may be used in conjunction with this device to achieve the goals sought by the method presented; and
optionally allowing for pre-programmed variables to assist the user in efficient use of the device.
